(19) United States
(12) Patent Application Publication
(10) Pub. No.: US 2026/0194988 A1
(43) Pub. Date: Jul. 9, 2026

(54) ELECTRONIC APPARATUS AND METHOD FOR CONTROLLING ELECTRONIC APPARATUS

(71) Applicant: SAMSUNG ELECTRONICS CO., LTD., Suwon-si (KR)

(72) Inventors: Sihong PARK, Suwon-si (KR); Yongjae KIM, Suwon-si (KR); Inhak NA, Suwon-si (KR); Hukwon KIM, Suwon-si (KR)

(73) Assignee: SAMSUNG ELECTRONICS CO., LTD., Suwon-si (KR)

(21) Appl. No.: 19/543,282

(22) Filed: Feb. 18, 2026

Related U.S. Application Data
(63) Continuation of application No. PCT/KR2026/000350, filed on Jan. 7, 2026.

(30) Foreign Application Priority Data
Jan. 7, 2025 (KR) 10-2025-0002162
Apr. 3, 2025 (KR) 10-2025-0043372

(51) Int. Cl. G06F 3/033; G06F 3/01; G06F 3/042; G06F 3/04842; G06F 3/04845; G06F 3/0487

(52) U.S. Cl. CPC G06F 3/0334; G06F 3/011; G06F 3/0425; G06F 3/04842; G06F 3/04845; G06F 3/0487

(57) ABSTRACT

An electronic apparatus may include: a camera; a driving unit configured to move the electronic apparatus; a projection unit configured to output light from a light source onto a projection surface external of the electronic apparatus; a memory configured to store instructions; and one or more processors configured to, collectively or individually, execute the stored instructions to: project, by the projection unit, a user interface (UI) including a plurality of UI elements onto the projection surface, obtain, by the camera, an image related to a movement of a user indicative of a selection by the user of a projected UI element of the projected plurality of UI elements, obtain, from the obtained image, information corresponding to a distance between feature regions associated with a foot of the user and the electronic apparatus, and based on the obtained information, select the projected UI element of the projected plurality of UI elements.

### CROSS-REFERENCE TO RELATED APPLICATIONS

This application is a continuation of International Application No. PCT/KR2026/000350 designating the United States, filed on Jan. 7, 2026, in the Korean Intellectual Property Receiving Office and claiming priority to Korean Patent Application No. 10-2025-0002162, filed on Jan. 7, 2025, in the Korean Intellectual Property Office, and Korean Patent Application No. 10-2025-0043372 filed on Apr. 3, 2025, in the Korean Intellectual Property Office, the disclosures of each of which are incorporated by reference herein in their entireties.

### BACKGROUND

### Field

The present disclosure relates to an electronic apparatus and a method for controlling the electronic apparatus, and more particularly, relates to an electronic apparatus for controlling an electronic apparatus by detecting a movement of a user and a method for controlling the electronic apparatus.

### Description of Related Art

An artificial intelligence system refers to a computer system implementing intelligence at a human level, and refers to a system in which a machine learns and determines on its own and a recognition rate increases as the machine is used.

Artificial intelligence technology includes machine learning (deep learning) technology using an algorithm for classifying and learning features of input data on its own, and element technologies for simulating functions such as cognition and determination of a human brain by utilizing a machine learning algorithm.

The element technologies includes, for example, at least one of: linguistic understanding technology for identifying human language or characters; visual understanding technology for identifying an object similar to human vision; inference or prediction technology for determining information and logically inferring and predicting; knowledge representation technology for processing human experience information as knowledge data; or motion control technology for controlling autonomous driving of a vehicle or movement of a robot. In particular, visual understanding refers to technology for identifying and processing an object similar to human vision, and includes object recognition, object tracking, image retrieval, person recognition, scene understanding, spatial understanding, image enhancement, or the like. In addition, inference or prediction refers to technology for determining information and logically inferring and predicting, and includes knowledge/probability-based inference, optimization prediction, preference-based planning, recommendation, or the like.

Meanwhile, in recent years, an electronic apparatus performing various functions while moving in a specific space (e.g., a home or a restaurant) is under development. For example, various electronic apparatuses such as a mobile projector, a robot vacuum cleaner, a serving robot, and a guidance robot perform various functions while moving in a specific space.

In case of a mobile electronic apparatus such as a mobile projector, when a user having difficulty in movement such as a mobility-impaired user inputs a user command for controlling the electronic apparatus, difficulty may exist in inputting the user command due to a limitation in movement.

### SUMMARY

In accordance with the present disclosure, an electronic apparatus may include: a camera; a driving unit configured to move the electronic apparatus; a projection unit configured to output light from a light source onto a projection surface external of the electronic apparatus; a memory configured to store instructions; and one or more processors configured to, collectively or individually, execute the stored instructions to: project, by the projection unit, a user interface (UI) including a plurality of UI elements onto the projection surface, obtain, by the camera, an image related to a movement of a user indicative of a selection by the user of a projected UI element of the projected plurality of UI elements, obtain, from the obtained image, information corresponding to a distance between a feature region associated with a foot of the user and the electronic apparatus, and based on the obtained information, select the projected UI element of the projected plurality of UI elements that the user indicates is selected by the movement of the user.

The stored instructions may be further configured to: determine whether the user is on a wheelchair, based on a determination that the user is on a wheelchair, identify the user as a wheelchair user, and with the user being identified as a wheelchair user, obtain the feature region associated with the foot of the user.

The feature region may include: a first feature region corresponding to a first frame of the wheelchair corresponding to a right foot of the wheelchair user and a footrest of the wheelchair for the right foot of the wheelchair user, and a second feature region corresponding to a second frame of the wheelchair corresponding to a left foot of the wheelchair user and a footrest of the wheelchair for the left foot of the wheelchair user.

The stored instructions may be further configured to: based on the obtained information corresponding to the distance between the feature region and the electronic apparatus, obtain information about a direction in which the wheelchair user is rotated as a rotation direction of the wheelchair user, and based on the obtained information about the rotation direction, select a UI element of the plurality of UI elements that corresponds to the rotation direction.

The stored instructions may be further configured to: with a first distance between the first feature region and the electronic apparatus being shorter than a second distance between the second feature region and the electronic apparatus, identify the rotation direction as a counterclockwise direction, and with the first distance longer than the second distance, identify the rotation direction as a clockwise direction.

The stored instructions may be further configured to: before a movement of the wheelchair user, obtain a correction value based on a difference between a first distance between the first feature region and the electronic apparatus and a second distance between the second feature region and the electronic apparatus, and based on the obtained correction value and the obtained information, select the projected UI element of the projected plurality of UI elements.

The stored instructions may be further configured to: obtain, by the camera, an image of the user before the movement of the user, and with the projected UI not parallel to the user based on the obtained image of the user before the movement of the user, perform keystone correction to configure the projected UI to be parallel to the user.

The stored instructions may be further configured to: obtain, by the camera, an image of the user before the movement of the user, and with the projected UI not parallel to the user based on the obtained image of the user before the movement of the user, move, by the driving unit, the electronic apparatus such that the user and the projected UI are parallel.

The stored instructions may be configured to: based on detection of a first event that corresponds to the projected UI and is associated with a first user, among a plurality of users, who is not on a wheelchair, move, by the driving unit, the electronic apparatus to a region corresponding to the first user, project, by the projection unit, the UI to the region corresponding to the first user, and based on a movement of a foot of the first user, obtain information about a dominant foot of the first user.

The stored instructions may be further configured to: with the information about the dominant foot of the first user obtained, based on detection of a second event that corresponds to the projected UI and is associated with the first user, move, by the driving unit, the electronic apparatus to the region corresponding to the first user, and project, by the projection unit, a modified UI in which placement of UI elements of the plurality of UI element is modified based on the obtained information about the dominant foot of the first user.

In accordance with the present disclosure a method for controlling an electronic apparatus including a camera, a driving unit configured to move the electronic apparatus, a projection unit configured to output light from a light source onto a projection surface external of the electronic apparatus, a memory configured to store instructions, and one or more processors configured to, collectively or individually, execute the stored instructions, may include: by the one or more processors, projecting, by the projection unit, a user interface (UI) including a plurality of UI elements onto the projection surface, obtaining, by the camera, an image related to a movement of a user indicative of a selection by the user of a projected UI element of the projected plurality of UI elements, obtaining, from the obtained image, information corresponding to a distance between a feature region associated with a foot of the user and the electronic apparatus, and based on the obtained information, selecting the projected UI element of the projected plurality of UI elements that the user indicates is selected by the movement of the user.

The method may further include: determining whether the user is on a wheelchair, based on a determination that the user is on a wheelchair, identifying the user as a wheelchair user, and with the user being identified as a wheelchair user, obtaining the feature region associated with the foot of the user.

The feature region may include: a first feature region corresponding to a first frame of the wheelchair corresponding to a right foot of the wheelchair user and a footrest of the wheelchair for the right foot of the wheelchair user, and a second feature region corresponding to a second frame of the wheelchair corresponding to a left foot of the wheelchair user and a footrest of the wheelchair for the left foot of the wheelchair user.

The selecting may include: based on the obtained information corresponding to the distance between the feature region and the electronic apparatus, obtaining information about a direction in which the wheelchair user is rotated as a rotation direction of the wheelchair user, and based on the obtained information about the direction in which the wheelchair user is rotated, selecting a UI element of the plurality of UI elements that corresponds to the rotation direction.

The identifying may include: with a first distance between the first feature region and the electronic apparatus being shorter than a second distance between the second feature region and the electronic apparatus, identifying the rotation direction as a counterclockwise direction, and with the first distance longer than the second distance, identifying the rotation direction as a clockwise direction.

The method may further include: obtaining a correction value based on a difference between a first distance between the first feature region and the electronic apparatus and a second distance between the second feature region and the electronic apparatus before the user moves, and the selecting may include selecting the one of the plurality of UI elements based on the correction value and the information corresponding to the distance.

The method may include: performing keystone correction to make the UI parallel to the user when the UI and the user are not parallel to each other based on the image captured by using the camera before the user moves.

The method may include: driving the electronic apparatus to make the user and the UI parallel to each other when the user and the UI are not parallel to each other based on the image captured by using the camera before the user moves.

The method may include: driving the electronic apparatus to a region corresponding to a first user among a plurality of users based on a first event when the first event corresponding to UI projection based on the first user who is not the wheelchair user is detected; obtaining information on a dominant foot of the first user based on movement of a foot of the first user while projecting the UI to the region corresponding to the first user; driving the electronic apparatus to the region corresponding to the first user based on a second event when the information on the dominant foot of the first user is obtained and the second event corresponding to UI projection is then detected based on the first user; and projecting a modified UI in which placement of the UI element included in the UI is modified based on the information on the dominant foot of the first user.

According to an embodiment of the present disclosure, provided is a non-transitory computer-readable medium storing instructions for executing a method for controlling an electronic apparatus including a camera and a projection unit, wherein the method includes: projecting a user interface (UI) including a plurality of UI elements by using the projection unit; obtaining an image related to movement of a user corresponding to selection of one of the plurality of UI elements by using the camera; obtaining, from the image, information corresponding to a distance between a plurality of feature regions associated with a foot of the user and the electronic apparatus; and selecting the one of the plurality of UI elements based on the information corresponding to the distance.

### BRIEF DESCRIPTION OF THE DRAWINGS

FIG. 1 is a diagram illustrating an electronic apparatus for receiving a user command from a wheelchair user according to an embodiment of the present disclosure.

FIG. 2 is a block diagram illustrating a configuration of the electronic apparatus according to an embodiment of the present disclosure.

FIGS. 3A and 3B are diagrams illustrating an appearance of the electronic apparatus according to various embodiments of the present disclosure.

FIG. 4 is a flowchart illustrating an embodiment in which a user interface (UI) element is selected based on movement of a foot of the user according to an embodiment of the present disclosure.

FIG. 5 is a diagram illustrating a plurality of feature regions according to an embodiment of the present disclosure.

FIGS. 6A and 6B are diagrams illustrating an embodiment in which a UI element is selected based on movement of a foot of the user according to an embodiment of the present disclosure.

FIGS. 7A to 8C are diagrams illustrating a method for correcting a UI to be parallel to the user according to an embodiment of the present disclosure.

FIG. 9 is a flowchart illustrating a method for controlling the electronic apparatus capable of providing a user interface (UI) corresponding to a plurality of user characteristics according to an embodiment of the present disclosure.

FIGS. 10A to 11B are diagrams illustrating a method for correcting a UI based on user characteristics according to an embodiment of the present disclosure.

### DETAILED DESCRIPTION

The disclosure may be variously modified and have several embodiments, and specific embodiments of the disclosure are thus illustrated in the accompanying drawings and described in detail in the specification. However, it should be understood that the scope of the present disclosure are not limited to specific embodiments, and include all modifications, equivalents, and alternatives according to an embodiment of the present disclosure. Throughout the accompanying drawings, similar components are denoted by similar reference numerals.

In describing the present disclosure, omitted is a detailed description of a case where it is decided that a detailed description of the known functions or configurations related to the present disclosure may unnecessarily obscure the gist of the present disclosure.

In addition, the following embodiment may be modified in several different forms, and the scope and spirit of the present disclosure are not limited to the following embodiments. Rather, these embodiments make the disclosure thorough and complete, and are provided to completely convey the spirit of the disclosure to those skilled in the art.

Terms used in the disclosure are used only to describe the specific embodiments rather than limit the scope of the disclosure. A term of a singular number may include its plural number unless explicitly indicated otherwise in the context.

In the present disclosure, the expression such as “have”, “may have”, “include”, or “may include”, indicates the presence of a corresponding feature (e.g., a numerical value, a function, an operation, or a component such as a part), and does not exclude the presence of an additional feature.

In the present disclosure, the expression such as “A or B”, “least one of A and/or B”, or “one or more of A and/or B” may include all possible combinations of items enumerated together. For example, “A or B”, “at least one of A and B”, or “at least one of A or B” may indicate all of 1) a case in which at least one A is included, 2) a case in which at least one B is included, or 3) a case in which both of at least one A and at least one B are included.

The expressions such as “first” and “second”, used in the present disclosure, may indicate various components regardless of the sequence and/or importance of the components. These expressions are only used to distinguish one component and another component from each other, and do not limit the corresponding components.

When any component (e.g., a first component) is mentioned to be “(operatively or communicatively) coupled with/to” or “connected to” another component (e.g., a second component), it should be understood that the any component is directly coupled to another component or may be coupled to another component through yet another component (e.g., a third component).

On the other hand, when any component (e.g., the first component) is mentioned to be “directly coupled with/to” or “directly connected to” another component (e.g., the second component), it should be understood that yet another component (e.g., the third component) is not present between any component and another component.

An expression such as “configured (or set) to”, “used in the present disclosure, may be replaced by an expression such as “suitable for”, “having the capacity to”, “designed to”, “adapted to”, “made to”, or “capable of”, depending on a context. The expression “configured (or set) to” does not necessarily indicate “specifically designed to” in terms of hardware.

Instead, the expression “a device configured to,” in any context, may indicate that the device may “perform~” together with another device or component. For example, a “processor configured (or set) to perform A, B, and C” may indicate a dedicated processor (e.g., an embedded processor) that may perform the corresponding operations or a generic-purpose processor (e.g., a central processing unit (CPU) or an application processor) that may perform the corresponding operations by executing one or more software programs stored in a memory device.

In the embodiments, a “module” or a “part” may perform at least one function or operation, and be implemented by hardware or software or be implemented by a combination of hardware and software. In addition, a plurality of “modules” or a plurality of “parts” may be integrated in at least one module and be implemented by at least one processor except for a “module” or a “part” that needs to be implemented by specific hardware.

In an embodiment, a “state” may be replaceable with terms such as “condition” or “mode.” For example, a “wall projection state” may be replaceable with “wall projection condition” or “wall projection mode.”

Meanwhile, various elements and regions in the drawings are schematically illustrated. Therefore, the spirit of the present disclosure is not limited by relative sizes or intervals illustrated in the accompanying drawings.

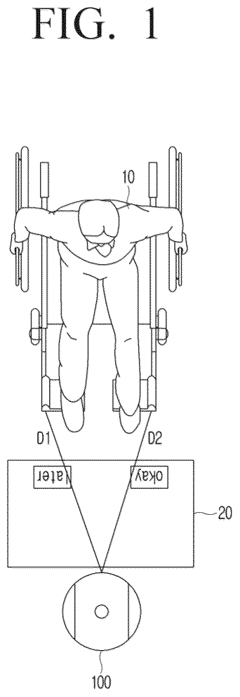

FIG. 1 is a diagram illustrating an electronic apparatus for receiving a user command from a wheelchair user according to an embodiment of the present disclosure. According to an embodiment of the present disclosure, an electronic apparatus 100 may be implemented as a mobile projector as illustrated in FIG. 1, which is merely an embodiment, and may be implemented as various mobile electronic apparatuses such as a robot.

In particular, according to an embodiment of the present disclosure, the electronic apparatus 100 may include a projector for projecting an image. Here, the projector refers to a device for projecting an image onto a screen, wall, or floor by using light. The projector may process a received image signal and project an enlarged processed image signal by using a light source and a lens system.

In particular, the projector may include a long-throw projection lens and an ultra-short-throw projection lens. The projector may project an image to a position distant from a wall or a screen installed on the wall by using the long-throw projection lens. In addition, the projector may project an image to a position proximate to a wall or a floor by using the ultra-short-throw projection lens.

According to an embodiment of the present disclosure, the electronic apparatus 100 may move toward the user and project (e.g., provide or output) a user interface (UI) around the user (e.g., in front of the user). Here, the UI may include a plurality of UI elements for receiving the user command from the user.

In at least one embodiment, the electronic apparatus 100 may select one of the plurality of UI elements based on movement of a hand or foot of the user. For example, the electronic apparatus 100 may select a UI element disposed on a left side when movement of the hand or foot of the user toward the left side is detected. In addition, the electronic apparatus 100 may select a UI element disposed on a right side when movement of the hand or foot of the user in a counterclockwise direction is detected.

In at least one embodiment, the electronic apparatus 100 may identify a user having difficulty in movement (e.g., the wheelchair user) as illustrated in FIG. 1. When an event for projecting a UI 20 to the wheelchair user 10 is detected, the electronic apparatus 100 may project the UI 20 in front of the user 10 as illustrated in FIG. 1. Here, the UI 20 may include a first UI element (e.g., “later”) and a second UI element (e.g., “okay”).

In at least one embodiment, the electronic apparatus 100 may obtain an image (e.g., an depth image) for obtaining information on movement of the user for selecting one of the plurality of UI elements through a camera (e.g., a depth camera). The electronic apparatus 100 may extract a plurality of feature regions associated with a foot of the user from the image. In at least one embodiment, the plurality of feature regions may include: a first feature region corresponding to a first frame of a wheelchair corresponding to a right foot of the user and a footrest for the right foot; and a second feature region corresponding to a second frame of the wheelchair corresponding to a left foot of the user and a footrest for the left foot.

The electronic apparatus 100 may obtain information corresponding to a distance between the plurality of feature regions and the electronic apparatus 100. In addition, the electronic apparatus 100 may identify information on movement (e.g., a rotation direction) of the user based on the information corresponding to the distance, and select one of the plurality of UI elements based on the identified movement of the user.

As described above, movement of the user having difficulty in movement may be detected and the UI elements may be used, thereby improving convenience for the user having difficulty in movement.

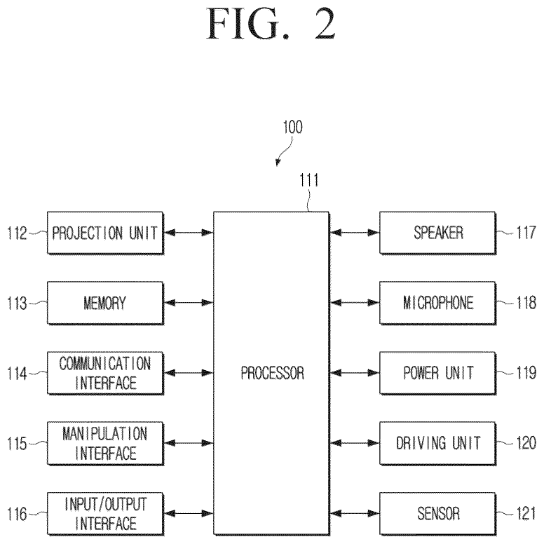

FIG. 2 is a block diagram illustrating a configuration of the electronic apparatus 100 according to an embodiment of the present disclosure. Referring to FIG. 2, the electronic apparatus 100 may include at least one of a processor 111, a projection unit 112, a memory 113, a communication interface 114, a manipulation interface 115, an input/output interface 116, a speaker 117, a microphone 118, a power unit 119, a driving unit 120, or a sensor 121. Meanwhile, the configuration illustrated in FIG. 2 corresponds to merely one of various embodiments, and some configurations may be omitted, and new configurations may be added.

The projection unit 112 refers to a component for projecting an image to the outside. According to the various embodiments of the present disclosure, the projection unit 112 may be implemented as any of various projection types (e.g., a cathode-ray tube (CRT) type, a liquid crystal display (LCD) type, a digital light processing (DLP) type, or a laser type). For example, the CRT type may basically use the same principle as a CRT monitor. The CRT type may display an image on a screen by magnifying the image by using a lens disposed in front of the cathode-ray tube (CRT). The CRT type may be classified into a single-tube type and a three-tube type based on the number of cathode-ray tubes, and in case of the three-tube type, red, green, and blue cathode-ray tubes may be implemented separately.

In another example, the LCD type may display an image by passing light output from a light source through a liquid crystal. The LCD type may be classified into a single-panel type and a three-panel type. In case of the three-panel type, light output from the light source may be separated into red, green, and blue by a dichroic mirror (i.e., a mirror that reflects light of a specific color and transmits the others), may then pass through the liquid crystal, and may then be focused again onto a single point.

In another example, the DLP type may display an image by using a digital micromirror device (DMD) chip. The DLP-type projection unit may include a light source, a color wheel, the DMD chip, a projection lens, or the like. Light output from the light source may be colored as light passes through a rotating color wheel. Light passed through the color wheel may be input to the DMD chip. The DMD chip may include numerous micromirrors and reflect light input into the DMD chip. The projection lens may serve to magnify light reflected from the DMD chip into an image size.

In another example, the laser type may include a diode-pumped solid-state (DPSS) laser and a galvanometer. The laser type that outputs various colors may use a laser in which three DPSS lasers are respectively installed for red, green, and blue (RGB) colors, and their optical axes then overlap with one another by using a special mirror. The galvanometer may include a mirror and a high-power motor to move the mirror at a high speed. For example, the galvanometer may rotate the mirror at up to 40 KHz/sec. The galvanometer may be mounted in a scanning direction. In general, the projector may perform a flatbed scanning, and the galvanometer may thus also be divided into x and y axes.

Meanwhile, the projection unit 112 may include various types of light sources. For example, the projection unit 112 may include at least one light source among a lamp, a light-emitting diode (LED), and a laser.

The projection unit 112 may output an image in an aspect ratio of 4:3, an aspect ratio of 5:4, or a wide aspect ratio of 16:9, based on a purpose of the electronic apparatus 100, a user setting, or the like, and may output the image having any of various resolutions such as wide video graphics array (WVGA, 854×480 pixels), super video graphics array (SVGA, 800×600 pixels), extended graphics array (XGA, 1024×768 pixels), wide extended graphics array (WXGA, 1280×720 pixels), WXGA (1280×800 pixels), super extended graphics array (SXGA, 1280×10²⁴ pixels), ultra extended graphics array (UXGA, 1600×1200 pixels) and full high-definition (full HD, 1920×1080 pixels), based on the aspect ratio.

Meanwhile, the projection unit 112 may perform various functions to adjust the output image under control of the processor 111. For example, the projection unit 112 may perform a zoom function, a keystone function, a quick corner (four-corner) keystone function, a lens shift function, or the like.

In detail, the projection unit 112 may enlarge or reduce an image based on its distance (i.e., a projection distance) from a screen. That is, the projection unit 112 may perform the zoom function based on the distance from the screen. Here, the zoom function may include a hardware method for adjusting a screen size by moving a lens, and a software method for adjusting the screen size by cropping the image, or the like. If the zoom function is performed, a focus of the image is required to be adjusted. For example, a method for adjusting the focus may include a manual focusing method and an electric focusing method. The manual focusing method refers to a method of manually adjusting the focus, and the electric focusing method refers to a method in which the projector automatically adjusts the focus by using a motor built therein upon performing the zoom function. Meanwhile, when the zoom function is performed, the projection unit 112 may provide a digital zoom function by using software, and may provide an optical zoom function that performs the zoom function in which the zoom function is performed by moving the lens by using a rotation unit.

In addition, the projection unit 112 may perform the keystone correction function. If a projection height does not match the front projection, the screen may be distorted upward or downward. The keystone correction function refers to a function for correcting such screen distortion. For example, if the screen is distorted leftward or rightward, the distortion may be corrected by using a horizontal keystone, and if the screen is distorted upward or downward, the distortion may be corrected by using a vertical keystone. The quick corner (four-corner) keystone correction function refers to a function for correcting the screen when a center region of the screen is normal and a corner region thereof is unbalanced. The lens shift function refers to a function for moving the screen position without distorting the screen when the screen is out of the projection range.

Meanwhile, the projection unit 112 may provide the zoom, keystone, and focusing functions by automatically analyzing a surrounding environment and a projection environment without a user input. In detail, the projection unit 112 may automatically provide the zoom, keystone, and focusing functions based on a distance between the electronic apparatus 100 and a screen, information about a space where the electronic apparatus 100 is currently positioned, information about an amount of ambient light, or the like, detected by the sensor (e.g., the camera, a distance sensor, an infrared sensor, or an illuminance sensor).

In addition, the projection unit 112 may provide a lighting function by using a light source. In particular, the projection unit 112 may provide the lighting function by outputting light from the light source such as an LED. According to the various embodiments, the projection unit 112 may include one LED, and according to another embodiment, the electronic apparatus 100 may include a plurality of LEDs. In an implementation example, the projection unit 112 may output light from the light source by using a surface-emitting LED. The surface-emitting LED may refer to an LED in which an optical sheet is disposed on an upper side of the LED for evenly distributing light from the light source and outputting the same. In detail, when light from the light source is output through the LED, light from the light source may be evenly distributed through the optical sheet, and light from the light source that is distributed through the optical sheet may be incident on a display panel.

Meanwhile, the projection unit 112 may provide the user with a dimming function for adjusting an intensity of light from the light source. In detail, if the user input for adjusting the intensity of light from the light source is received from the user through the manipulation interface 115 (e.g., a touch display button or a dial button), the projection unit 112 may control the LED to output light at an intensity of light from the light source corresponding to the received user input.

In addition, the projection unit 112 may provide the dimming function based on content analyzed by the processor 111 without the user input. In detail, the projection unit 112 may control the LED to output light at the intensity of light from the light source based on information (e.g., content type or content brightness) about the currently-provided content.

Meanwhile, the projection unit 112 may control a color temperature under the control of the processor 111. Here, the processor 111 may control the color temperature based on content. In detail, when the content to be output is identified, the processor 111 may obtain frame-by-frame color information of the content whose output is determined. In addition, the processor 111 may control the color temperature based on the obtained frame-by-frame color information. Here, the processor 111 may obtain at least one major color of a frame based on the frame-by-frame color information. In addition, the processor 111 may adjust the color temperature based on at least one obtained major color. For example, the color temperature adjustable by the processor 111 may be classified into a warm type or a cold type. Here, it is assumed that a frame to be output (hereinafter, an output frame) includes a scene where a fire occurs. The processor 111 may identify (or obtain) that the major color is red based on the color information included in a current output frame. In addition, the processor 111 may identify the color temperature corresponding to the identified major color (red). Here, the color temperature corresponding to red may be the warm type. Meanwhile, the processor 111 may use the artificial intelligence model to obtain the color information or major color of the frame. According to the various embodiments, the artificial intelligence model may be stored in the electronic apparatus 100 (e.g., the memory 113). According to another embodiment, the artificial intelligence model may be stored in an external server capable of communicating with the electronic apparatus 100.

Meanwhile, the projection unit 112 may include a long-throw projection lens and an ultra-short-throw projection lens. The long-throw projection lens refers to a lens capable of projecting a large screen at a long distance, and may project an image even at a position several meters to several tens of meters away from the screen. The ultra-short-throw projection lens refers to a lens capable of projecting a large screen at a very short distance, and may project an image even at a position several tens of centimeters away from the screen.

In addition, the projection unit 112 may further include a switching unit for switching (or changing or tilting) between the long-throw projection lens and the ultra-short-throw projection lens. That is, the projection unit 112 may switch between the long-throw projection lens and the ultra-short-throw projection lens by using the switching unit under the control of the processor 111.

The memory 113 may be implemented as an internal memory such as a read only memory (ROM) (e.g., an electrically erasable and programmable read-only memory (EEPROM)) or a random access memory (RAM) included in the processor 111, or may be implemented as a memory separate from the processor 111. In this case, the memory 113 may be implemented as a memory embedded in the electronic apparatus 100 or as a memory detachable from the electronic apparatus 100 based on a data storage purpose. For example, data for driving the electronic apparatus 100 may be stored in the memory embedded in the electronic apparatus 100, and data for expanded functions of the electronic apparatus 100 may be stored in the memory detachable from the electronic apparatus 100.

Meanwhile, the memory embedded in the electronic apparatus 100 may be implemented as at least one of: a volatile memory (e.g., a dynamic RAM (DRAM)), a static RAM (SRAM), or a synchronous dynamic RAM (SDRAM)); or a non-volatile memory (e.g., a one time programmable ROM (OTPROM), programmable ROM (PROM), an erasable and programmable ROM (EPROM), an electrically erasable and programmable ROM (EEPROM), a mask ROM, a flash ROM, a flash memory (e.g., a NAND flash or a NOR flash), a hard drive, or a solid state drive (SSD)). The memory detachable from the electronic apparatus 100 may be implemented as a memory card (e.g., a compact flash (CF), a secure digital (SD), a micro secure digital (Micro-SD), a mini secure digital (Mini-SD), an extreme digital (xD), or a multimedia card (MMC)), or an external memory connectable to a universal serial bus (USB) port (e.g., a USB memory).

The memory 113 may store at least one instruction related to the electronic apparatus 100. In addition, the memory 113 may store an operating system (O/S) for driving the electronic apparatus 100. In addition, the memory 113 may store various software programs or applications for operating the electronic apparatus 100 according to the various embodiments of the present disclosure. In addition, the memory 113 may include a semiconductor memory such as a flash memory or a magnetic storage medium such as a hard disk.

In detail, the memory 113 may store various software modules for operating the electronic apparatus 100 according to the various embodiments of the present disclosure, and the processor 111 may control an operation of the electronic apparatus 100 by executing the various software modules stored in the memory 113. That is, the memory 113 may be accessed by the processor 111, and the processor 111 may perform reading, writing, modification, deletion, update, or the like of data.

In particular, the memory 113 may store information on a map of an interior of a home in which the electronic apparatus 100 is positioned. Here, the map may include a drawing representing a planar structure of the home, scaled down to a predetermined ratio by using predetermined symbols. For example, the map may include a line drawing representing the planar structure of the interior of the home. However, the present disclosure is not limited thereto, and the map may include positions of major objects within the home.

Meanwhile, the map according to an embodiment of the present disclosure may correspond to a two-dimensional map, which is merely an embodiment, and may correspond to a three-dimensional map.

Meanwhile, the term “memory 113” in the present disclosure is used to include a storage unit, a ROM (not shown) or a RAM (not shown) installed in the processor 111, or a memory card (not shown) mounted on the electronic apparatus 100 (e.g., a micro SD card or a memory stick).

The communication interface 114 refers to a component for performing communication with various types of external devices by using various types of communication methods. The communication interface 114 may include a wireless communication module or a wired communication module. Here, each communication module may be implemented as at least one hardware chip.

The wireless communication module refers to a module for performing communication with the external device in a wireless manner. For example, the wireless communication module may include at least one module selected from a wireless fidelity (Wi-Fi) module, a Bluetooth module, an infrared communication module, or other communication modules.

The Wi-Fi module and Bluetooth module may perform communication in a Wi-Fi manner and a Bluetooth manner, respectively. In case of using the Wi-Fi module or the Bluetooth module, the communication interface 114 may first transmit and receive various connection information such as a service set identifier (SSID) or a session key, and connect the communication based on this connection information, and then transmit and receive various information.

The infrared communication module may perform communication based on infrared data association (IrDA) technology that wirelessly transmits data in a short distance using an infrared ray between visible light and millimeter waves.

Other communication modules may include at least one communication chip performing the communication based on various wireless communication standards such as Zigbee, third generation (3G), third generation partnership project (3GPP), long term evolution (LTE), LTE advanced (LTE-A), fourth generation (4G), and fifth generation (5G), in addition to the above-described communication methods.

The wired communication module refers to a module for performing the communication with the external device in a wired manner. For example, the wired communication module may include at least one of a local area network (LAN) module, an Ethernet module, a pair cable, a coaxial cable, an optical fiber cable, or an ultrawideband (UWB) module.

In particular, the communication interface 114 may communicate with the external device 200. The communication interface 114 may receive, from the external device 200, information on the external device 200 (e.g., information on a current position of the external device 200 or information on a device disposed in the external device 200). The communication interface 114 may transmit path information to the external device 200, and may transmit information on a multi-projector system.

The manipulation interface 115 may include various types of input devices. For example, the manipulation interface 115 may include a physical button. Here, the physical button may include a function key, a directional key (e.g., a four-way key), or a dial button. According to the various embodiments, the physical button may be implemented as a plurality of keys. According to another embodiment, the physical button may be implemented as one key. If the physical button is implemented as one key, the electronic apparatus 100 may receive a user input in which one key is pressed for a threshold time or more. Upon receiving the user input in which one key is pressed for the threshold time or more, the processor 111 may perform a function corresponding to the user input. For example, the processor 111 may provide a lighting function based on the user input.

In addition, the manipulation interface 115 may receive the user input using a non-contact method. If the user input is received using a contact method, a physical force is required to be transmitted to the electronic apparatus 100. Therefore, there is a need for a method for controlling the electronic apparatus 100 regardless of the physical force. In detail, the manipulation interface 115 may receive a user gesture and perform an operation corresponding to the received user gesture. Here, the manipulation interface 115 may receive the user gesture from the sensor (e.g., the image sensor or the infrared sensor).

In addition, manipulation interface 115 may receive the user input by using a touch method. For example, the manipulation interface 115 may receive the user input from a touch sensor. According to the various embodiments, the touch method may be implemented in a non-contact manner. For example, the touch sensor may determine whether a user body approaches within a threshold distance. The touch sensor may identify the user input even if the user does not come into contact with the touch sensor. In another implementation example, the touch sensor may identify the user input if the user comes into contact with the touch sensor.

Meanwhile, the electronic apparatus 100 may receive the user input in various ways other than the manipulation interface 115 described above. In the various embodiments, the electronic apparatus 100 may receive the user input from an external remote control device. Here, the external remote control device may refer to a remote control device corresponding to the electronic apparatus 100 (e.g., a dedicated control device of the electronic apparatus 100) or a portable communication device of the user (e.g., a smartphone or a wearable device). Here, the portable communication device of the user may store an application for controlling the electronic apparatus 100. The portable communication device may obtain the user input from the application stored therein and transmit the obtained user input to the electronic apparatus 100. The electronic apparatus 100 may receive the user input from the portable communication device and perform an operation corresponding to a user control command.

Meanwhile, the electronic apparatus 100 may receive the user input by using voice recognition. According to the various embodiments, the electronic apparatus 100 may receive the user voice from the microphone included in the electronic apparatus 100. According to another embodiment, the electronic apparatus 100 may receive the user voice from the microphone or the external device. In detail, the external device may obtain the user voice from the microphone of the external device and transmit the obtained user voice to the electronic apparatus 100. The user voice transmitted from the external device may be audio data or digital data converted from the audio data (e.g., audio data converted into a frequency domain). The electronic apparatus 100 may perform an operation corresponding to the received user voice. In detail, the electronic apparatus 100 may receive the audio data corresponding to the user voice from the microphone. In addition, the electronic apparatus 100 may convert the received audio data into the digital data. In addition, the electronic apparatus 100 may convert the converted digital data into text data by using a speech-to-text (STT) function. According to the various embodiments, the electronic apparatus 100 may directly perform the speech-to-text (STT) function. According to another embodiment, the external server may perform the speech-to-text (STT) function. The electronic apparatus 100 may transmit the digital data to the external server. The external server may convert the digital data into the text data and obtain control command data based on the converted text data. The external server may transmit the control command data to the electronic apparatus 100 (here, the control command data may also include the text data). The electronic apparatus 100 may perform an operation corresponding to the user voice based on the obtained control command data.

Meanwhile, the electronic apparatus 100 may provide a voice recognition function by using a single assistant (or an AI assistant, e.g., Bixby™), which is only one of various embodiments, and may provide the voice recognition function by using a plurality of assistants. Here, the electronic apparatus 100 may provide the voice recognition function by selecting one of the plurality of assistants based on a trigger word corresponding to the assistant or a specific key included in a remote control.

Meanwhile, electronic apparatus 100 may receive the user input by using screen interaction. The screen interaction may refer to a function for identifying whether a predetermined event occurs based on an image projected onto a screen (or a projection surface) by the electronic apparatus 100 and obtaining the user input based on the predetermined event. Here, the predetermined event may refer to an event in which a predetermined object is identified at a specific position (e.g., a position at which a user interface (UI) for receiving the user input is projected). Here, the predetermined object may include at least one of a body part of the user (e.g., a finger, a hand, or a foot), a pointer, or a laser point. If the predetermined object is identified at the position corresponding to the projected UI, the electronic apparatus 100 may identify that the user input for selecting the projected UI is received. For example, the electronic apparatus 100 may project a guide image for guiding the UI to be displayed on the screen. In addition, the electronic apparatus 100 may identify whether the user selects the projected UI. In detail, the electronic apparatus 100 may identify that the user selects the projected UI if the predetermined event is identified at the position of the projected UI. Here, the projected UI may include at least one item. Here, the electronic apparatus 100 may perform a space analysis to identify whether the predetermined event occurs at the position of the projected UI. Here, the electronic apparatus 100 may perform the space analysis by using the sensor (e.g., the image sensor, the infrared sensor, the depth camera, or the distance sensor). By performing the space analysis, the electronic apparatus 100 may identify whether the predetermined event occurs at the specific position (the position at which the UI is projected). In addition, if the predetermined event is identified as occurring at the specific position (the position at which the UI is projected), the electronic apparatus 100 may identify that the user input for selecting the UI corresponding to the specific position is received.

In particular, the manipulation interface 115 may receive a user command for operating a multi-projection function. In an embodiment, a touch or jog icon for receiving a user command may be provided through a display. In addition, when the touch or jog icon is selected through the touch display or the like of the manipulation interface 115, the electronic apparatus 100 may receive the user command (e.g., the user command for operating the multi-projection function, or the like).

The input/output interface 116 refers to a component for inputting and outputting at least one of the audio signal or an image signal. The input/output interface 116 may receive at least one of the audio signal or the image signal from the external device, and output the control command to the external device.

In an implementation example, the input/output interface 116 may be implemented as including an interface for inputting and outputting only the audio signal and an interface for inputting and outputting only the image signal, or as a single interface for inputting and outputting both the audio signal and the image signal.

Meanwhile, according to the various embodiments of the present disclosure, the input/output interface 116 may be implemented as at least one of wired input/output interfaces such as a high definition multimedia interface (HDMI), a mobile high-definition link (MHL), a universal serial bus (USB), a USB C-type, a DisplayPort (DP), Thunderbolt, a video graphics array (VGA) port, a red-green-blue (RGB) port, a D-subminiature (D-SUB), or a digital visual interface (DVI). According to the various embodiments, the wired input/output interface may be implemented as including an interface for inputting and outputting only the audio signal and an interface for inputting and outputting only the image signal, or as one interface for inputting and outputting both the audio signal and the image signal.

In addition, the electronic apparatus 100 may receive data through the wired input/output interface, which is only one of the various embodiments, and may receive power through the wired input/output interface. For example, the electronic apparatus 100 may receive power from an external battery through the USB C-type or from a power outlet through a power adapter. In another example, the electronic apparatus 100 may receive power from the external device (e.g., a laptop or a monitor) through the DP.

Meanwhile, the audio signal may be implemented to be input through the wired input/output interface, and the image signal may be implemented to be input through a wireless input/output interface (or the communication interface). Alternatively, the audio signal may be implemented to be input through the wireless input/output interface (or the communication interface), and the image signal may be implemented to be input through the wired input/output interface.

The speaker 117 refers to a component for outputting an audio signal. In particular, the speaker 117 may include an audio output mixer, an audio signal processor, and an audio output module. The audio output mixer may synthesize a plurality of audio signals to be output into at least one audio signal. For example, the audio output mixer may synthesize an analog audio signal with another analog audio signal (e.g., an analog audio signal received from an external source) into at least one analog audio signal. The audio output module may include the speaker or an output terminal. According to the various embodiments, the audio output module may include a plurality of speakers. In this case, the audio output module may be disposed inside a body, and audio emitted by covering at least a portion of a diaphragm included in the audio output module may pass through a waveguide and be transmitted to the outside of the body. The audio output module may include a plurality of audio output units, and the plurality of audio output units may be arranged symmetrically on an exterior of the body, thereby emitting the audio in all directions, i.e., 360 degrees.

The microphone 118 refers to a component for receiving user voice or other sound and converting the same into audio data. The microphone 118 may receive the user voice when activated. For example, the microphone 118 may be an integral type integrally formed on an upper side, a front side, a side portion, or the like of the electronic apparatus 100. The microphone 118 may include various configurations such as a microphone for collecting the user voice in an analog form, an amplifier circuit for amplifying the collected user voice, an analog to digital (A/D) conversion circuit for sampling the amplified user voice and converting the same into a digital signal, and a filter circuit for removing a noise component from the converted digital signal, and the like.

The power unit 119 may receive power from an external source and supply power to the various components of the electronic apparatus 100. According to the various embodiments of the present disclosure, the power unit 119 may receive power by using various methods. In the various embodiments, the power unit 119 may receive power by using a connector. In addition, the power unit 119 may receive power by using a direct current (DC) power cord of 220 V. However, the present disclosure is not limited thereto, and the electronic apparatus 100 may receive power by using a USB power cord or may receive power by using a wireless charging method.

In addition, the power unit 119 may receive power from an internal battery or an external battery. According to the various embodiments of the present disclosure, the power unit 119 may receive power from the internal battery. For example, the power unit 119 may charge power of the internal battery by using at least one of the DC power cord of 220 V, the USB power cord, or a USB C-Type power cord, and may receive power from the charged internal battery. In addition, according to the various embodiments of the present disclosure, the power unit 119 may receive power from the external battery. For example, the power unit 119 may receive power from the external battery when electronic apparatus 100 and the external battery are connected to each other by using various wired communication methods such as the USB power cord, the USB C-Type power cord, and a socket groove. That is, the power unit 119 may receive power directly from the external battery, or charge the internal battery by using the external battery and then receive power from the charged internal battery.

The power unit 119 according to the present disclosure may receive power by using at least one of the plurality of power supply methods described above.

Meanwhile, regarding power consumption, the electronic apparatus 100 may have power consumption equal to or lower than a predetermined value (e.g., 43 watt (W)) due to a socket type, another standard, or the like. Here, the electronic apparatus 100 may change the power consumption to reduce power consumption when a battery is used. That is, the electronic apparatus 100 may change the power consumption based on the power supply method, power usage, or the like.

The driving unit 120 may drive at least one hardware component included in the electronic apparatus 100. The driving unit 120 may generate the physical force and transmit the physical force to at least one hardware component included in the electronic apparatus 100. Here, the driving unit 120 may generate driving power for movement of the hardware component included in the electronic apparatus 100 (e.g., movement of the electronic apparatus 100).

In particular, the driving unit 120 may move a position of the electronic apparatus 100. Here, the driving unit 120 may control a moving member 109 to move the electronic apparatus 100. For example, the driving unit 120 may control the moving member 109 by using a motor and a wheel. Meanwhile, according to the present disclosure, the driving unit 120 may be referred to by various terms such as a traveling unit, an operating unit, or a moving unit.

The sensor 121 may include at least one sensor. In detail, the sensor 121 may include at least one of a tilt sensor for sensing tilt of the electronic apparatus 100 or an image sensor for capturing an image. Here, the tilt sensor may be implemented as an accelerometer or a gyro sensor, and an image sensor may be implemented as the camera or the depth camera. Meanwhile, the tilt sensor may be referred to as a movement sensor. In addition, the sensor 121 may include various sensors other than the tilt sensor or the image sensor. For example, the sensor 121 may include an illuminance sensor or a distance sensor. The distance sensor may be implemented as a time of flight (ToF) sensor. In addition, the sensor 121 may include a light detection and ranging (LiDAR) sensor.

In particular, the sensor 121 may obtain a sensing value for obtaining information on whether the external device 200 is positioned within a detection range by using at least one sensor. In addition, the sensor 121 may obtain information on an obstacle within the detection range by using at least one sensor.

In addition, the sensor 121 may include at least one camera for obtaining a distance from the user. In at least one embodiment, the camera may be implemented as a depth camera. Here, the depth camera refers to a camera for measuring depth (distance) information from an object (e.g., the user). While a general RGB camera provides only color information, the depth camera may obtain a depth map including a distance value for each pixel. In at least one embodiment, the camera may be implemented as a plurality of cameras. In detail, the plurality of cameras may be disposed at predetermined intervals (baselines) to obtain the depth information by using a triangulation method. In addition, the electronic apparatus 100 may find coordinates of the same object by using a stereo matching technique and calculate the distance. In particular, the electronic apparatus 100 may find the same object from the plurality of images captured by the plurality of cameras and calculate pixel difference (disparity) to obtain a disparity map. Here, the larger the disparity value included in the disparity map, the closer the distance, and the smaller the disparity value, the farther the distance. However, this configuration is merely an embodiment, and various methods may be used to obtain the distance between the electronic apparatus 100 and the user.

Meanwhile, the electronic apparatus 100 may control the lighting function in conjunction with an external device. In detail, the electronic apparatus 100 may receive lighting information from the external device. Here, the lighting information may include at least one of brightness information or color temperature information, set by the external device. Here, the external device refers to a device connected to the same network as the electronic apparatus 100 (e.g., an Internet of Things (IoT) device included in the same home or company network) or a device not connected to the same network as the electronic apparatus 100 but capable of communicating with the electronic apparatus 100 (e.g., a remote control server). For example, it may be assumed that an external lighting device (e.g., an IoT device) included in the same network as the electronic apparatus 100 outputs red light at a brightness of 50. The external lighting device (e.g., the IoT device) may directly or indirectly transmit the lighting information (e.g., information indicating that red light is output at the brightness of 50) to the electronic apparatus 100. Here, the electronic apparatus 100 may control an output of the light source based on the lighting information received from the external lighting device. For example, the electronic apparatus 100 may output red light at the brightness of 50 when the lighting information received from the external lighting device includes the information indicating that red light is output at the brightness of 50.

Meanwhile, the electronic apparatus 100 may control the lighting function based on biometric information. In detail, the processor 111 may obtain biometric information of the user. Here, the biometric information may include at least one of body temperature, heart rate, blood pressure, respiration, or electrocardiogram of the user. Here, the biometric information may include various information other than the above information. For example, the electronic apparatus 100 may include a sensor for measuring the biometric information. The processor 111 may obtain the biometric information of the user by using the sensor and control the output of the light source based on the obtained biometric information. In another example, the processor 111 may receive the biometric information from the external device through the input/output interface 116. Here, the external device may be implemented as a portable communication device (e.g., a smartphone or a wearable device) of the user. The processor 111 may obtain the biometric information of the user from the external device and control the output of the light source based on the obtained biometric information. Meanwhile, in an implementation example, the electronic apparatus 100 may identify whether the user is sleeping, and the processor 111 may control the output of the light source based on the biometric information of the user when it is identified that the user is sleeping (or preparing to sleep).

Meanwhile, the electronic apparatus 100 according to the various embodiments of the present disclosure may provide various smart functions.

In detail, the electronic apparatus 100 may be connected to a portable terminal device for controlling the electronic apparatus 100, and a screen output from the electronic apparatus 100 may be controlled by the user input that is input from the portable terminal device. For example, the portable terminal device may be implemented as a smartphone including a touch display, and the electronic apparatus 100 may receive screen data provided from the portable terminal device from the portable terminal device and output the data, and the screen output by the electronic apparatus 100 may be controlled based on the user input that is input from the portable terminal device.

The electronic apparatus 100 may be connected to the portable terminal device by using various communication methods such as miracast, airplay, wireless dalvik executable (DEX) and a remote personal computer (PC) method, and may share content or music, provided from the portable terminal device.

In addition, the portable terminal device and the electronic apparatus 100 may be connected to each other by various connection methods. In the various embodiments, the portable terminal device may search for the electronic apparatus 100 and perform a wireless connection, or the electronic apparatus 100 may search for the portable terminal device and perform the wireless connection. In addition, the electronic apparatus 100 may output the content provided from the portable terminal device.

In the various embodiments, the electronic apparatus 100 may output content or music being output from the portable terminal device when the portable terminal device is positioned near the electronic apparatus 100, and a predetermined gesture (e.g., motion tap view) is then detected through a display of the portable terminal device in a state where specific content or music is being output from the portable terminal device.

In the various embodiments, the electronic apparatus 100 may output the content or music being output from the portable terminal device when the portable terminal device is positioned around the electronic apparatus 100 by a predetermined distance or less (e.g., non-contact tap view), or when the portable terminal device is brought into contact with the electronic apparatus 100 twice at short intervals (e.g., contact tap view) in the state where the specific content or music is being output from the portable terminal device.

The above-described embodiment describes that the screen provided by the portable terminal device is the same as the screen provided from the electronic apparatus 100. However, the disclosure is not limited thereto. That is, when connection between the portable terminal device and the electronic apparatus 100 is established, the portable terminal device may output a first screen provided from the portable terminal device, and the electronic apparatus 100 may output a second screen provided from the portable terminal device, which is different from the first screen. For example, the first screen may be implemented as a screen provided from a first application installed in the portable terminal device, and the second screen may be implemented as a screen provided from a second application installed in the portable terminal device. For example, the first screen and the second screen may be different screens provided from one application installed in the portable terminal device. In addition, for example, the first screen may be implemented as a screen including a remote controller-type UI for controlling the second screen.

The electronic apparatus 100 according to the present disclosure may output a standby screen. For example, the electronic apparatus 100 may output the standby screen when the electronic apparatus 100 is not connected to the external device or when no input is received from the external device for a predetermined time. A condition for the electronic apparatus 100 to output the standby screen is not limited to the above-described embodiment, and the standby screen may be output based on various conditions.

The electronic apparatus 100 may output a standby screen in a blue-screen form, and the present disclosure is not limited thereto. For example, the electronic apparatus 100 may obtain a non-standard object by extracting only a shape of a specific object from data received from the external device, and output the standby screen including the obtained non-standard object.

Meanwhile, the electronic apparatus 100 may further include a display (not shown).

The display (not shown) may be implemented as various types of displays such as a liquid crystal display (LCD), an organic light-emitting diode (OLED) display, or a plasma display panel (PDP). The display (not shown) may include a driving circuit implemented as an amorphous silicon thin film transistor (a-si TFT), a low temperature poly silicon (LTPS) TFT, or an organic TFT (OTFT), a backlight unit, and the like. Meanwhile, the display (not shown) may be implemented as a touch screen combined with a touch sensor, a flexible display, a three-dimensional (3D) display, or the like. In addition, the display (not shown) according to the various embodiments of the present disclosure may include not only a display panel for outputting the image, but also a bezel for housing the display panel. In particular, the bezel according to the various embodiments of the present disclosure may include a touch sensor (not shown) for detecting user interaction.

Meanwhile, the electronic apparatus 100 may further include a shutter unit (not shown).

The shutter unit (not shown) may include at least one of a shutter, a fixing member, a rail, or a body.

Here, the shutter may block light output from the projection unit 112. Here, the fixing member may fix a position of the shutter. Here, the rail may serve as a path for moving the shutter and the fixing member. Here, the body may be implemented as a component including the shutter and the fixing member.

The processor 111 may be implemented as a digital signal processor (DSP), a microprocessor, or a timing controller (T-CON) for processing digital signals. However, the present disclosure is not limited thereto, and the processor 111 may include at least one of a central processing unit (CPU), a micro controller unit (MCU), a micro processing unit (MPU), a controller, an application processor (AP), a graphics processing unit (GPU), a communication processor (CP), or an advanced RISC machine (ARM) processor, or may be defined by these terms. In addition, the processor 111 may be implemented as a system-on-chip (SoC) or a large scale integration (LSI), in which a processing algorithm is embedded, or may be implemented as a field programmable gate array (FPGA). In addition, the processor 111 may perform various functions by executing computer executable instructions stored in the memory 113.

In particular, the processor 111 may project a UI including the plurality of UI elements by using the projection unit 112 by executing at least one instruction stored in the memory 113. The processor 111 may obtain an image related to movement of the user corresponding to a selection of one of the plurality of UI elements by using the camera. The processor 111 may obtain, from the image, the information corresponding to the distance between the plurality of feature regions associated with the foot of the user and the electronic apparatus 100. The processor 111 may select one of the plurality of UI elements based on the information corresponding to the distance.

In at least one embodiment, the processor 111 may obtain (or extract) the plurality of feature regions associated with the foot of the user when the user is identified as the wheelchair user. Here, the plurality of feature regions may include: the first feature region corresponding to the first frame of the wheelchair corresponding to a right foot of the user and the footrest for the right foot; and the second feature region corresponding to the second frame of the wheelchair corresponding to a left foot of the user and the footrest for the left foot.

In at least one embodiment, the processor 111 may obtain (or identify) the information on the rotation direction of the user based on the information corresponding to the distance between the plurality of feature regions and the electronic apparatus 100, and select a UI element corresponding to the rotation direction of the user among the plurality of UI elements based on the information on the rotation direction of the user.

In at least one embodiment, the processor 111 may identify that the user rotates counterclockwise when a first distance between the first feature region and the electronic apparatus 100 is shorter than a second distance between the second feature region and the electronic apparatus 100, and the processor 111 may identify that the user rotates clockwise when the first distance is longer than the second distance.

In at least one embodiment, the processor 111 may obtain a correction value based on a difference between the first distance between the first feature region and the electronic apparatus 100 and the second distance between the second feature region and the electronic apparatus 100 before the user moves, and select one of the plurality of UI elements based on the correction value and the information corresponding to the distance.

In at least one embodiment, the processor 111 may perform the keystone correction to make the user and the UI parallel to each other when the UI and the user are not parallel to each other based on an image captured by using the camera before the user moves.

In at least one embodiment, the processor 111 may drive the electronic apparatus 100 to make the user and the UI parallel to each other when the UI and the user are not parallel to each other based on the image captured by using the camera before the user moves.

In at least one embodiment, the processor 111 may control the driving unit 120 to drive the electronic apparatus 100 to a region corresponding to a first user based on a first event when the first event corresponding to the UI projection is identified based on the first user who is not the wheelchair user among the plurality of users, and may obtain information on a dominant foot of the first user based on movement of a foot of the first user while projecting the UI to the region corresponding to the first user.

In addition, the processor 111 may control the driving unit 120 to drive the electronic apparatus 100 to the region corresponding to the first user based on a second event when the processor 111 obtains the information on the dominant foot of the first user and then the second event corresponding to a UI projection is detected based on the first user, and may project a modified UI in which the placement of a UI element included in the UI is modified based on the information on the dominant foot of the first user.

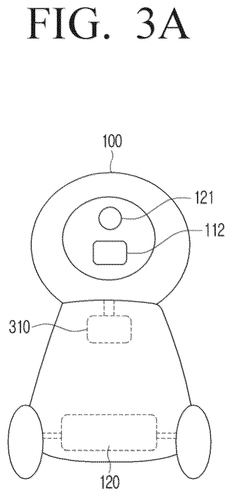

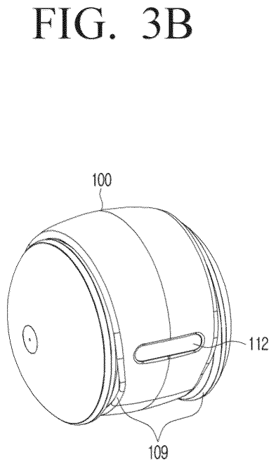

FIGS. 3A and 3B are diagrams illustrating an appearance of the electronic apparatus 100 according to the various embodiments of the present disclosure. As illustrated in FIG. 3A, the electronic apparatus 100 may include the sensor 121 (e.g., the camera) and the projection unit 112 in a head region. Here, the head region refers to a region positioned at an upper end of the electronic apparatus 100 and may be referred to by various terms such as an upper region, a top region, a detection region, or a projection region. In addition, the head region of the electronic apparatus 100 may be rotated to adjust a projection angle of the electronic apparatus 100 or sense information on surroundings of the electronic apparatus 100. Here, the head region of the electronic apparatus 100 may be rotated by a rotation unit 310 illustrated in FIG. 3. In at least one embodiment, the head region of the electronic apparatus 100 may perform a yaw rotation for rotating the electronic apparatus 100 in a left-right direction. In addition, the head region of the electronic apparatus 100 may perform a pitch rotation for rotating the electronic apparatus 100 in an up-down direction. In addition, the head region of the electronic apparatus 100 may perform a roll rotation for rotating the electronic apparatus 100 in a clockwise or counterclockwise direction. However, although the head region of the electronic apparatus 100 is rotated in all three-axis directions, which is merely an embodiment, and the head region may be rotated only in a part of the three-axis directions.

In addition, the driving unit 120 may be included in a lower region of the electronic apparatus 100. The driving unit 120 may drive the moving member (i.e., a wheel) to move the electronic apparatus 100.

That is, the electronic apparatus 100 may adjust the projection angle of the electronic apparatus 100 through the rotation unit 310 and adjust a projection position of the electronic apparatus 100 through the driving unit 120.

FIG. 3B is a diagram illustrating an appearance of the electronic apparatus according to an embodiment of the present disclosure. Referring to an embodiment illustrated in FIG. 3, the electronic apparatus 100 may include the moving member 109. The moving member 109 refers to a member for moving the electronic apparatus 100 from a first position to a second position in a space where the electronic apparatus 100 is disposed. The electronic apparatus 100 may control the moving member 109 to move the electronic apparatus 100 by using a force generated from the driving unit 120. Here, the moving member 109 may include a motor or a wheel. In addition, as illustrated in FIG. 3B, the electronic apparatus 100 may include the projection unit 112 disposed on one region of the body.

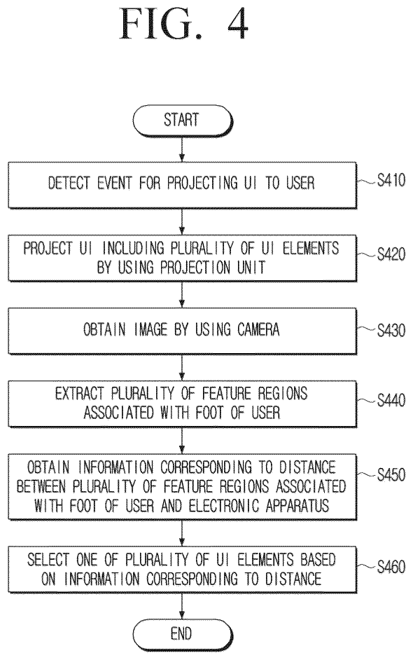

FIG. 4 is a flowchart illustrating an embodiment in which a user interface (UI) element is selected based on movement of a foot of the user according to an embodiment of the present disclosure.

In the following embodiment, respective operations may be performed sequentially, and respective operations may not be necessarily performed sequentially. For example, a sequence of the respective operations may be changed or at least two operations may be performed in parallel.

According to an embodiment, operations S410 to S460 may be understood to be performed by a processor (e.g., the processor 111 illustrated in FIG. 2) of an electronic apparatus (e.g., the electronic apparatus 100 in FIG. 2).

In at least one embodiment, the electronic apparatus 100 may detect an event for projecting a UI to the user (S410). Here, the event for projecting the UI refers to an event in which the user inputs a UI projection command, is not limited thereto, and may include various events such as an event in a predetermined time reaches or an event in which the user approaches the electronic apparatus 100.

The electronic apparatus 100 may project the UI including the plurality of UI elements by using the projection unit 112 (S420). In detail, the electronic apparatus 100 may identify a user position. In at least one embodiment, the electronic apparatus 100 may identify the user position by using the sensor and the camera. However, the electronic apparatus 100 is not limited thereto, and may identify the user position by receiving user position information from the external device. In addition, the electronic apparatus 100 may move to surroundings of the user (or a region corresponding to the user) through the driving unit 120 based on the user position. The electronic apparatus 100 may identify a projection surface onto which the UI is projected in surroundings of the user. Here, the projection surface refers to a region on which the electronic apparatus 100 projects an image. For example, the projection surface may be implemented as a floor, which is merely an embodiment, and the projection surface may be implemented as a wall or a screen of a predetermined color (e.g., white). In addition, the electronic apparatus 100 may project the UI including the plurality of UI elements onto the identified projection surface. Here, the UI may include various UI elements such as UI elements including information to be provided to the user and UI elements for controlling the electronic apparatus 100. Here, the UI elements may be implemented as various elements such as icons, items, thumbnail images, or indicators.

The electronic apparatus 100 may obtain an image by using the camera (S430). Here, the image refers to an image including the user, and may be used to obtain the information on movement of the user for selecting one of the plurality of UI elements. Here, the camera may be implemented as a depth camera, is not limited thereto, and may be implemented as a plurality of cameras. Here, the image may correspond to a depth image, is not limited thereto, and may correspond to an RGB image.

The electronic apparatus 100 may extract the plurality of feature regions associated with the foot of the user (S440). In detail, the electronic apparatus 100 may identify whether the user is the wheelchair user by analyzing the captured image. When the user is identified as the wheelchair user, the electronic apparatus 100 may extract the plurality of feature regions associated with the foot of the user.

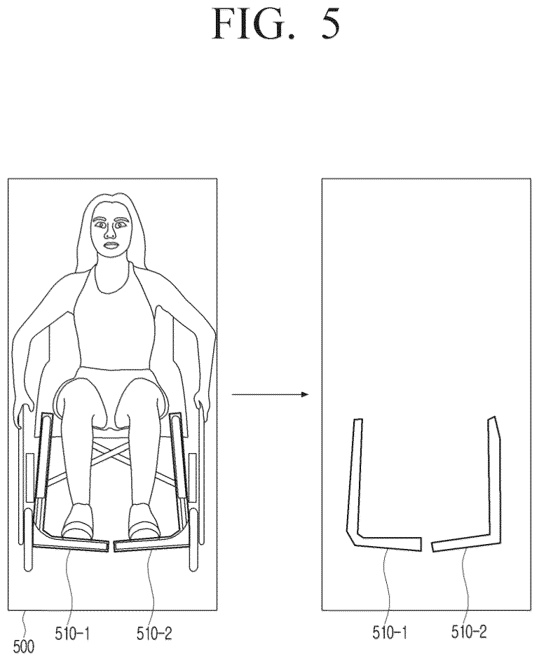

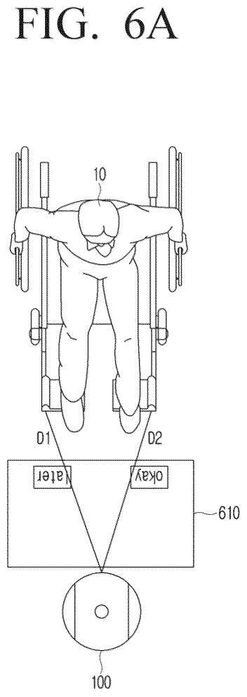

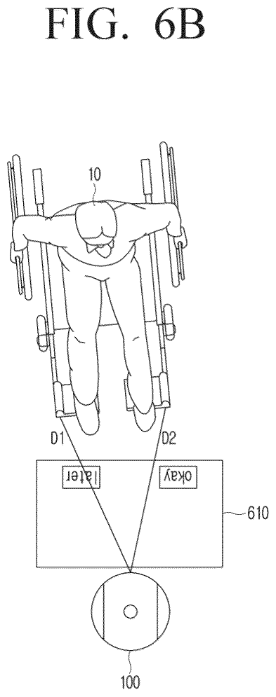

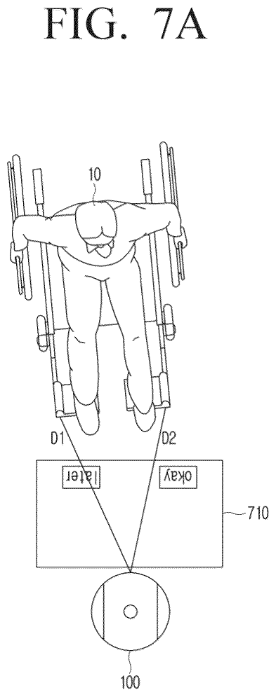

In at least one embodiment, as illustrated on a left side of FIG. 5, the electronic apparatus 100 may obtain an image 500 including the user. Here, the image 500 may include the wheelchair user. In addition, the electronic apparatus 100 may extract, from the image 500, a first feature region 510-1 corresponding to the first frame of the wheelchair corresponding to a right foot of the user and the footrest for the right foot, and a second feature region 510-2 corresponding to the second frame of the wheelchair corresponding to a left foot of the user and the footrest for the left foot. In addition, as illustrated on a right side of FIG. 5, the electronic apparatus 100 may obtain a feature region image including the first and second feature regions 510-1 and 510-2. Meanwhile, the feature region refers to a region related to movement of the user (in particular, movement of a foot) and is referred to by various terms such as an interest region or a target region.

Here, the electronic apparatus 100 may identify both feet of the user from the obtained image and extract the plurality of feature regions positioned around the identified both feet of the user. However, this configuration is merely an embodiment, and the electronic apparatus 100 may directly extract the plurality of feature regions. For example, the electronic apparatus 100 is unable to identify feet of the user when the user is missing at least one foot or is wearing a cast, and the electronic apparatus 100 thus may directly extract the plurality of feature regions without identifying feet of the user.

However, identifying the user as the wheelchair user is merely an embodiment, and the electronic apparatus 100 may identify another user with limited mobility (e.g., a user holding crutches or a mobility-impaired user with lower limb amputation). When the user corresponds to a general user, the electronic apparatus 100 may extract a foot or hand of the user as the feature region.

The electronic apparatus 100 may obtain the information corresponding to the distance between the plurality of feature regions associated with the foot of the user and the electronic apparatus 100 (S450). In detail, the electronic apparatus 100 may obtain the information on the rotation direction of the user based on the information corresponding to the distance between the plurality of feature regions and the electronic apparatus.

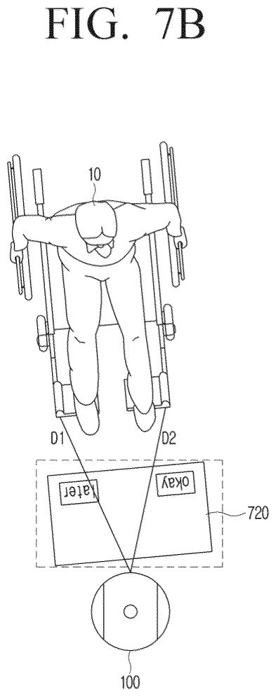

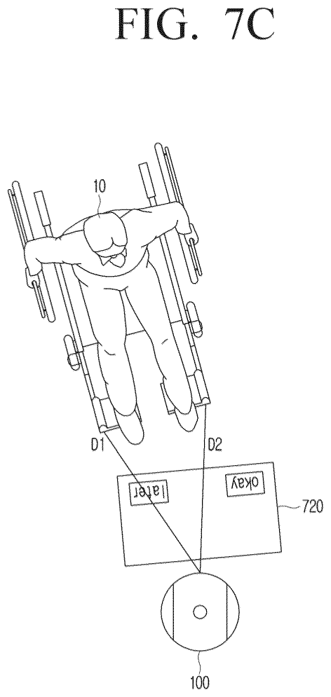

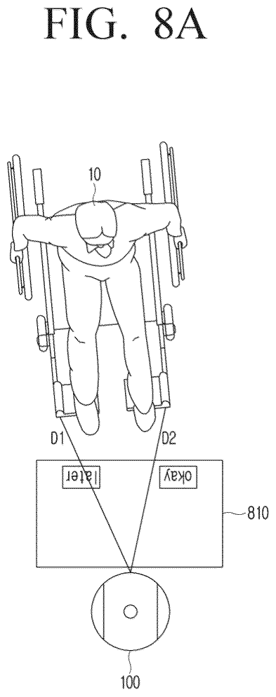

In at least one embodiment, as illustrated in FIG. 6A, before the user moves, the electronic apparatus 100 may obtain: information on a first distance D1 between a feature region corresponding to a right foot of a user 10 and the electronic apparatus 100; and a second distance D2 between a feature region corresponding to a left foot of the user 10 and the electronic apparatus 100 while a UI 610 is projected. Here, D1 and D2 may be the same as each other, and the present disclosure is not limited thereto.

Meanwhile, when D1 and D2 are not the same as each other, the electronic apparatus 100 may obtain a difference value between D1 and D2 as the correction value. Here, the correction value may be used when the rotation direction of the user is identified after the user moves.

In addition, when the user moves (or rotates), the electronic apparatus 100 may obtain the information corresponding to the distance between the plurality of feature regions associated with the foot of the user and the electronic apparatus 100. In detail, the electronic apparatus 100 may identify that the user rotates counterclockwise when the first distance D1 between the first feature region and the electronic apparatus 100 is shorter than the second distance D2 between the second feature region and the electronic apparatus 100. In addition, the electronic apparatus 100 may identify that the user rotates clockwise when the first distance D1 between the first feature region and the electronic apparatus 100 is longer than the second distance D2 between the second feature region and the electronic apparatus 100. This configuration may be expressed mathematically as follows.

$$D 1 - D 2 > 0 : Press Right \qquad [ Expression 1 ]$$

$$D 1 - D 2 < 0 : Press Left$$

In at least one embodiment, as illustrated in FIG. 6B, when a right foot of the user moves to face forward, the electronic apparatus 100 may identify that the first distance D1 becomes shorter than the second distance D2, and thus identify that the user rotates counterclockwise.

Meanwhile, when the first distance D1 and the second distance D2 are not the same each other before the user moves, that is, when the correction value exists, the electronic apparatus 100 may identify the rotation direction of the user based on the correction value and the information corresponding to the distance. In detail, the electronic apparatus 100 may identify the direction in which the user rotates by comparing the difference value between the first distance D1 and the second distance D2 and the correction value after the user moves. For example, the electronic apparatus 100 may identify that the user rotates counterclockwise when the difference value between the first distance D1 and the second distance D2 is greater than the correction value, and identify that the user rotates clockwise when the difference value between the first distance D1 and the second distance D2 is smaller than the correction value.

The electronic apparatus 100 may select one of the plurality of UI elements based on the information corresponding to the distance (S460). In detail, the electronic apparatus 100 may select a UI element corresponding to the rotation direction of the user identified based on the information corresponding to the distance. In addition, the electronic apparatus 100 may control a function of the electronic apparatus 100 based on the selected UI element.

In at least one embodiment, as illustrated in FIG. 6B, the electronic apparatus 100 may select the “later” UI element among the plurality of UI elements when the user rotates to make a right foot of the user face forward. As a result, the electronic apparatus 100 may execute a function corresponding to the selected UI element (e.g., a later selection function).

Meanwhile, as illustrated in FIG. 6A, although the user and the projected UI 610 are parallel to each other, the user and the projected UI are not parallel to each other at all times. When the user and the projected UI are not parallel to each other, malfunction may occur, and the electronic apparatus 100 may perform a correction operation to make the user and the projected UI 610 parallel to each other.

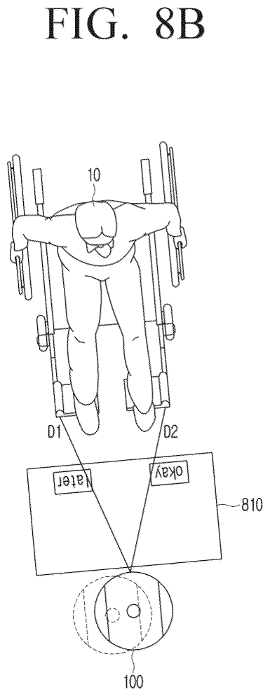

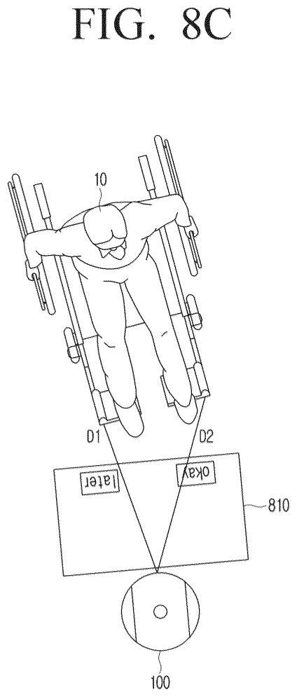

In at least one embodiment, the electronic apparatus 100 may identify whether the UI and the user 10 are parallel to each other based on the image captured by using the camera before the user moves. When a UI 710 and the user 10 are not parallel to each other, as illustrated in FIG. 7A, the electronic apparatus 100 may project a UI 720 by performing the keystone correction to make the UI 720 parallel to the user, as illustrated in FIG. 7B. That is, the electronic apparatus 100 may correct the UI 720 by performing the keystone correction to make the user and the UI 720 parallel to each other. In addition, when the user rotates counterclockwise, as illustrated in FIG. 7C, the electronic apparatus 100 may identify that the rotation direction of the user is rightward by using the same method described with reference to FIG. 4. In addition, the electronic apparatus 100 may select the “later” UI element positioned on a right side among the plurality of UI elements. As a result, the electronic apparatus 100 may execute a function corresponding to the selected UI element.

In at least one embodiment, the electronic apparatus 100 may identify whether a UI and the user 10 are parallel to each other based on the image captured by using the camera before the user moves. When a UI 810 and the user 10 are not parallel to each other, as illustrated in FIG. 8A, the electronic apparatus 100 may move a position of the electronic apparatus 100 to make the UI 810 parallel to the user by using the driving unit 120, as illustrated in FIG. 8B. As a result, the electronic apparatus 100 may project the UI 810 to be parallel to the user at the moved position. When the user rotates counterclockwise as illustrated in FIG. 8C, the electronic apparatus 100 may identify that the rotation direction of the user is rightward by using the same method described with reference to FIG. 4. In addition, the electronic apparatus 100 may select the “later” UI element positioned on a right side among the plurality of UI elements. As a result, the electronic apparatus 100 may execute a function corresponding to the selected UI element.

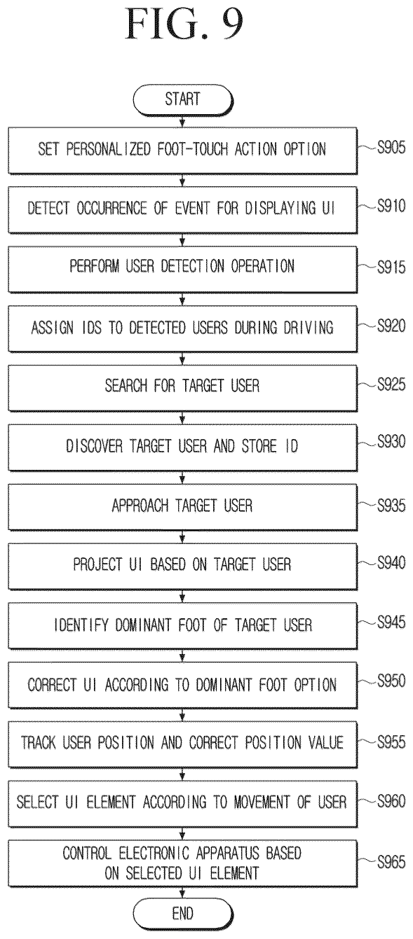

FIG. 9 is a flowchart for describing a method for controlling an electronic apparatus capable of providing a user interface (UI) corresponding to a plurality of user characteristics according to an embodiment of the present disclosure.

In the following embodiment, respective operations may be performed sequentially, and respective operations may not be necessarily performed sequentially. For example, a sequence of the respective operations may be changed or at least two operations may be performed in parallel.

According to an embodiment, operations S905 to S965 may be understood to be performed by a processor (e.g., the processor 111 illustrated in FIG. 2) of an electronic apparatus (e.g., the electronic apparatus 100 in FIG. 2).

In at least one embodiment, the electronic apparatus 100 may set a personalized foot-touch action option (S905). Here, a personalized foot-touch action refers to an action for providing a UI for a different foot-touch according to characteristics of the user (e.g., whether the user is the wheelchair user or a type of the dominant foot). In at least one embodiment, the electronic apparatus 100 may set the personalized foot-touch action option by using the electronic apparatus 100 or a mobile device associated with the electronic apparatus 100.

The electronic apparatus 100 may detect the occurrence of an event for displaying a UI (S910). In at least one embodiment, the electronic apparatus 100 may display the UI based on a personalized event occurring according to a request of the user. However, this configuration is merely an embodiment, and various events may occur, such as an event in which a predetermined time reaches or an event in which the user approaches the electronic apparatus 100.

The electronic apparatus 100 may perform a user detection operation (S915). In detail, the electronic apparatus 100 may detect a target user based on identification data of the user (e.g., a facial image) defined in an event of operation S910, and control the driving unit 120 to drive to a position of the detected target user.

The electronic apparatus 100 may assign (allocate) identifications (IDs) to detected users during driving (S920). That is, the electronic apparatus 100 may identify the detected users during driving and assign an ID to each identified user.

The electronic apparatus 100 may search for the target user (S925). In at least one embodiment, the electronic apparatus 100 may search for the target user by performing facial recognition based on the IDs of the users detected during driving.

The electronic apparatus 100 may discover the target user and store the ID (S930). In at least one embodiment, the electronic apparatus 100 may perform the facial recognition operation to identify, as the target user, a user whose identification data matches identification data of the user in the personalized event and store the ID of the identified target user.

The electronic apparatus 100 may approach the target user (S935). That is, the electronic apparatus 100 may approach the target user within a predetermined distance to provide a UI to the target user.

The electronic apparatus 100 may project a UI based on the target user (S940). In detail, the electronic apparatus 100 may project a UI for controlling information for the user, or a UI for controlling the electronic apparatus 100 or another electronic apparatus, based on characteristics of the target user. For example, the electronic apparatus 100 may project a UI by identifying whether the target user corresponds to a user having inconvenience in movement.

The electronic apparatus 100 may identify a dominant foot of the target user (S945). Here, the dominant foot refers to a foot frequently used by the user, and the electronic apparatus 100 may identify the dominant foot of the target user based on the stored information.

The electronic apparatus 100 may correct a UI according to a dominant foot option (S950). In at least one embodiment, the electronic apparatus 100 may correct a position of a UI element displayed in the UI according to the dominant foot of the target user when the dominant foot option is set to the electronic apparatus 100. When the user uses a right foot as the dominant foot, the electronic apparatus 100 may move a position of the UI element included in the UI to a right side to allow the user to easily select the UI element. Alternatively, when the user is the wheelchair user, the electronic apparatus 100 may provide a UI by using the same method described with reference to FIGS. 4 to 8C.

The electronic apparatus 100 may track a user position and correct a position value (S955). That is, when the user position is moved, the electronic apparatus 100 may track a moved position and correct the position value. In addition, the electronic apparatus 100 may select a UI element or move the UI according to the corrected position value.

The electronic apparatus 100 may select a UI element according to movement of the user (S960). In at least one embodiment, the electronic apparatus 100 may select a UI element positioned on a right side when the user moves to the right side.

The electronic apparatus 100 may control the electronic apparatus 100 based on the selected UI element (S965).

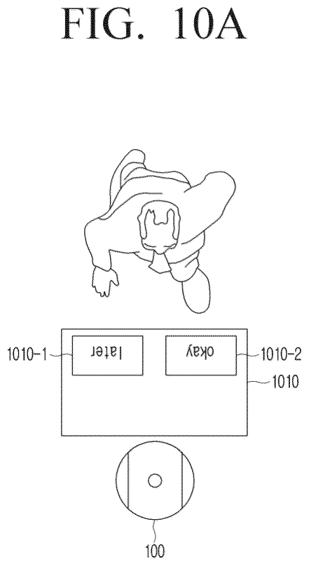

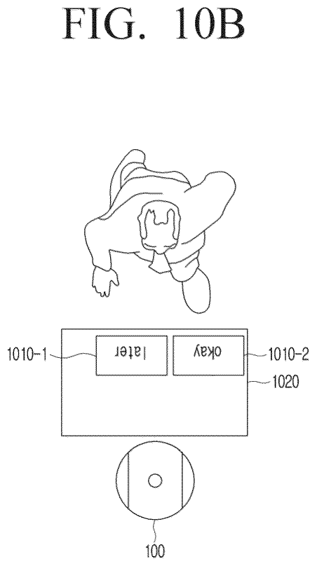

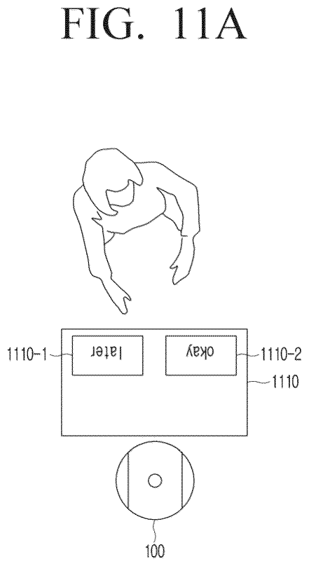

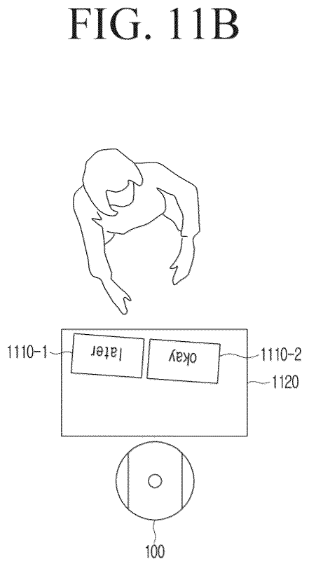

FIGS. 10A to 11B are diagrams illustrating a method for correcting the UI based on the user characteristics according to an embodiment of the present disclosure.

In at least one embodiment, the electronic apparatus 100 may control the driving unit 120 to drive to the first user in response to the first event when the first event for projecting a UI based on the first user who is not the wheelchair user among the plurality of users is detected. In addition, the electronic apparatus 100 may obtain and store information on a dominant foot frequently used by the first user based on movement of a foot of the first user while projecting the UI around the first user. For example, the electronic apparatus 100 may store a left foot of the first user as the dominant foot when the first user selects a UI element by using the left foot. However, this configuration is merely an embodiment, and the electronic apparatus 100 may obtain information on the dominant foot of the user by assigning IDs to the users and by tracking movements or actions of the user.

The electronic apparatus 100 may control the driving unit 120 to drive to the first user in response to the second event when the second event for projecting a UI to the first user is detected after the information on the dominant foot of the first user is stored. Here, as illustrated in FIG. 10A, the electronic apparatus 100 may project a UI 1010 including a first UI element 1010-1 and a second UI element 1010-2 around the first user.

The electronic apparatus 100 may control the projection unit 112 to project a modified UI in which the placement of a UI element included in the UI is modified based on the information on the dominant foot of the first user. For example, as illustrated in FIG. 10B, the electronic apparatus 100 may control the projection unit 112 to project a modified UI 1020 in which positions of the first UI element 1010-1 and the second UI element 1010-2 are moved to a left side to allow the UI elements 1010-1 and 1010-2 to be selected by using the left foot of the first user, which is the dominant foot.

Meanwhile, as described above, correcting the placement of the UI based on the dominant foot of the user is merely an embodiment, and the placement of the UI may be corrected based on a dominant hand of the user.

In detail, the electronic apparatus 100 may store a right hand of a second user as the dominant hand. The electronic apparatus 100 may control the driving unit 120 to drive to the second user in response to the second event when the second event for projecting a UI to the second user is detected after information on the dominant hand of the second user is stored. Here, as illustrated in FIG. 11A, the electronic apparatus 100 may project a UI 1110 including a first UI element 1110-1 and a second UI element 1110-2 around the second user.

The electronic apparatus 100 may control the projection unit 112 to project a modified UI in which the placement of a UI element included in the UI is modified based on information on the dominant hand of the second user. For example, as illustrated in FIG. 11B, the electronic apparatus 100 may control the projection unit 112 to project a modified UI 1120 in which positions of the first UI element 1110-1 and the second UI element 1110-2 are moved to a right side to allow the UI elements 1110-1 and 1110-2 to be selected by using the right hand of the second user, which is the dominant hand.

Meanwhile, the methods according to the various embodiments of the present disclosure may be included and provided in a computer program product. The computer program product may be traded as a commodity between a seller and a purchaser. The computer program product may be distributed in a form of the machine-readable storage medium (e.g., a compact disc read only memory (CD-ROM)), or may be distributed online (e.g., by download or upload) via an application store (e.g., PlayStore™) or directly between two user devices (e.g., smartphones). In case of the online distribution, at least a part of the computer program product (e.g., downloadable app) may be at least temporarily stored or temporarily provided in the machine-readable storage medium such as a server memory of a manufacturer, a server memory of an application store, or a relay server memory.

The various embodiments of the disclosure may be implemented by software including an instruction stored in the machine-readable storage medium (for example, the computer-readable storage medium). A machine may be an apparatus that invokes the stored instruction from the storage medium, may be operated based on the invoked instruction, and may include the electronic apparatus (e.g., a television (TV)) according to the disclosed embodiments.

Meanwhile, the machine-readable storage medium may be provided in the form of a non-transitory storage medium. Here, the “non-transitory storage medium” may refer to a tangible device and only indicate that this storage medium does not include a signal (e.g., electromagnetic wave), and this term does not distinguish a case where data is stored semi-permanently in the storage medium and a case where data is temporarily stored in the storage medium from each other. For example, the “non-transitory storage medium” may include a buffer in which data is temporarily stored.

In case that the instruction is executed by the processor, the processor may directly perform a function corresponding to the instruction, or perform the function by using other components under control of the processor. The instruction may include a code provided or executed by a compiler or an interpreter.

Although the embodiments of the present disclosure are shown and described as above, the present disclosure is not limited to the above-mentioned specific embodiments, and may be variously modified by those skilled in the art to which the present disclosure pertains without departing from the gist of the present disclosure as claimed in the accompanying claims. These modifications should also be understood to fall within the scope and spirit of the present disclosure.

What is claimed is:

1. An electronic apparatus comprising:
a camera;
a driving unit configured to move the electronic apparatus;
a projection unit configured to output light from a light source onto a projection surface external of the electronic apparatus;
a memory configured to store instructions; and
one or more processors configured to, collectively or individually, execute the stored instructions to:
project, by the projection unit, a user interface (UI) including a plurality of UI elements onto the projection surface,
obtain, by the camera, an image related to a movement of a user indicative of a selection by the user of a projected UI element of the projected plurality of UI elements,
obtain, from the obtained image, information corresponding to a distance between a feature region associated with a foot of the user and the electronic apparatus, and
based on the obtained information, select the projected UI element of the projected plurality of UI elements that the user indicates is selected by the movement of the user.

2. The electronic apparatus of claim 1, wherein the stored instructions are further configured to:
determine whether the user is on a wheelchair,
based on a determination that the user is on a wheelchair, identify the user as a wheelchair user, and
with the user being identified as a wheelchair user, obtain the feature region associated with the foot of the user.

3. The electronic apparatus of claim 2, wherein the feature region include:
a first feature region corresponding to a first frame of the wheelchair corresponding to a right foot of the wheelchair user and a footrest of the wheelchair for the right foot of the wheelchair user, and
a second feature region corresponding to a second frame of the wheelchair corresponding to a left foot of the wheelchair user and a footrest of the wheelchair for the left foot of the wheelchair user.

4. The electronic apparatus of claim 3, wherein the stored instructions are further configured to:
based on the obtained information corresponding to the distance between the feature region and the electronic apparatus, obtain information about a direction in which the wheelchair user is rotated as a rotation direction of the wheelchair user, and
based on the obtained information about the rotation direction, select a UI element of the plurality of UI elements that corresponds to the rotation direction.

5. The electronic apparatus of claim 4, wherein the stored instructions are further configured to:
with a first distance between the first feature region and the electronic apparatus being shorter than a second distance between the second feature region and the electronic apparatus, identify the rotation direction as a counterclockwise direction, and
with the first distance longer than the second distance, identify the rotation direction as a clockwise direction.

6. The electronic apparatus of claim 3, wherein the stored instructions are further configured to:
before a movement of the wheelchair user, obtain a correction value based on a difference between a first distance between the first feature region and the electronic apparatus and a second distance between the second feature region and the electronic apparatus, and
based on the obtained correction value and the obtained information, select the projected UI element of the projected plurality of UI elements.

7. The electronic apparatus of claim 1, wherein the stored instructions are further configured to:
obtain, by the camera, an image of the user before the movement of the user, and
with the projected UI not parallel to the user based on the obtained image of the user before the movement of the user, perform keystone correction to configure the projected UI to be parallel to the user.

8. The electronic apparatus of claim 1, wherein the stored instructions are further configured to:
obtain, by the camera, an image of the user before the movement of the user, and
with the projected UI not parallel to the user based on the obtained image of the user before the movement of the user,
move, by the driving unit, the electronic apparatus such that the user and the projected UI are parallel.

9. The electronic apparatus of claim 1, wherein the stored instructions are configured to:
based on detection of a first event that corresponds to the projected UI and is associated with a first user, among a plurality of users, who is not on a wheelchair, move, by the driving unit, the electronic apparatus to a region corresponding to the first user,
project, by the projection unit, the UI to the region corresponding to the first user, and
based on a movement of a foot of the first user, obtain information about a dominant foot of the first user.

10. The electronic apparatus of claim 9, wherein the stored instructions are further configured to:
with the information about the dominant foot of the first user obtained, based on detection of a second event that corresponds to the projected UI and is associated with the first user, move, by the driving unit, the electronic apparatus to the region corresponding to the first user, and
project, by the projection unit, a modified UI in which placement of UI elements of the plurality of UI element is modified based on the obtained information about the dominant foot of the first user.

11. A method for controlling an electronic apparatus including a camera, a driving unit configured to move the electronic apparatus, a projection unit configured to output light from a light source onto a projection surface external of the electronic apparatus, a memory configured to store instructions, and one or more processors configured to, collectively or individually, execute the stored instructions, the method comprising:
by the one or more processors,
projecting, by the projection unit, a user interface (UI) including a plurality of UI elements onto the projection surface,
obtaining, by the camera, an image related to a movement of a user indicative of a selection by the user of a projected UI element of the projected plurality of UI elements,
obtaining, from the obtained image, information corresponding to a distance between a feature region associated with a foot of the user and the electronic apparatus, and
based on the obtained information, selecting the projected UI element of the projected plurality of UI elements that the user indicates is selected by the movement of the user.

12. The method of claim 11, further comprising:
determining whether the user is on a wheelchair,
based on a determination that the user is on a wheelchair, identifying the user as a wheelchair user, and
with the user being identified as a wheelchair user, obtaining the feature region associated with the foot of the user.

13. The method of claim 12, wherein the feature region include:
a first feature region corresponding to a first frame of the wheelchair corresponding to a right foot of the wheelchair user and a footrest of the wheelchair for the right foot of the wheelchair user, and
a second feature region corresponding to a second frame of the wheelchair corresponding to a left foot of the wheelchair user and a footrest of the wheelchair for the left foot of the wheelchair user.

14. The method as claimed in claim 13, wherein the selecting includes:
based on the obtained information corresponding to the distance between the feature region and the electronic apparatus, obtaining information about a direction in which the wheelchair user is rotated as a rotation direction of the wheelchair user, and
based on the obtained information about the direction in which the wheelchair user is rotated, selecting a UI element of the plurality of UI elements that corresponds to the rotation direction.

15. The method as claimed in claim 14, wherein the identifying includes:
with a first distance between the first feature region and the electronic apparatus being shorter than a second distance between the second feature region and the electronic apparatus, identifying the rotation direction as a counterclockwise direction, and
with the first distance longer than the second distance, identifying the rotation direction as a clockwise direction.
